(19) United States
(12) Patent Application Publication
(10) Pub. No.: US 2011/0218319 A1
(43) Pub. Date: Sep. 8, 2011

(54) POLYARAMID FILMS COMPRISING FLUOROVINYLETHER FUNCTIONALIZED AROMATIC MOIETIES

(75) Inventors: Neville Everton Drysdale, Newark, DE (US); Kenneth Gene Moloy, Hockessin, DE (US); Fredrik Nederberg, Greenville, DE (US); Joel M. Pollino, Elkton, MD (US); Joachim C. Ritter, Wilmington, DE (US)

(73) Assignee: E. I. DU PONT DE NEMOURS AND COMPANY, Wilmington, DE (US)

(21) Appl. No.: 12/873,418

(22) Filed: Sep. 1, 2010

Related U.S. Application Data
(60) Provisional application No. 61/239,099, filed on Sep. 2, 2009.

(51) Int. Cl. C08G 69/42

(52) U.S. Cl. 528/339; 528/348

(57) ABSTRACT

Provided are polyaramid polymers and films made from the polymers, comprising repeat units of the condensation product of a fluorovinylether functionalized aromatic diacid chloride and an aromatic diamine, and methods to make the films.

### FIELD OF THE INVENTION

The invention is directed to films made from polyaramid polymers. The polymers comprise repeat units of the condensation product of a fluorovinylether functionalized aromatic diacid chloride and an aromatic diamine, and methods to make said polyaramid polymers. The films have reduced surface susceptibility to oil as compared to conventional films.

### BACKGROUND

Fluorinated materials have many uses. In particular, they are used in polymer-related industries, and, more particularly, in fiber-related industries, to impart soil and oil resistance. Generally, these materials are applied as a topical treatment, but their effectiveness decreases over time due to material loss via wear and washing.

There is a need to provide polymeric materials that have improved soil and oil resistance.

### SUMMARY OF THE INVENTION

In one aspect, the invention provides a polymer comprising a fluorovinyl ether functionalized aromatic repeat unit represented by the structure (I)

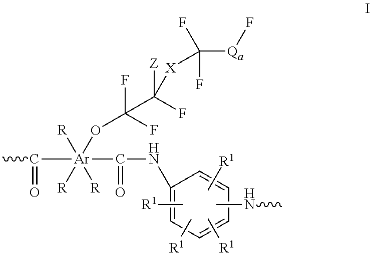

wherein,
Ar represents a benzene or naphthalene radical;
each R is independently H, C₁-C₁₀ alkyl, C₅-C₁₅ aryl, C₆-C₂₀ arylalkyl; OH, or a radical represented by the structure (II)

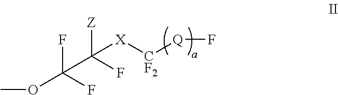

with the proviso that only one R can be OH or the radical represented by the structure (II);
Each R1 is independently H, C1-C10 alkyl, C5-C15 aryl, C6-C20 arylalkyl;

### X is O or CF₂;

### Z is H, Cl, or Br;

a=0 or 1;
and,
Q is represented by the structure (Ia)

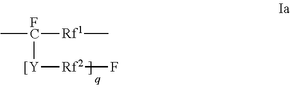

wherein q=0-10;
Y is O or CF₂;
Rf¹ is (CF₂)ₙ, wherein n is 0-10;
and,
Rf² is (CF₂)ₚ, wherein p is 0-10, with the proviso that when p is 0, Y is CF₂.

In another aspect, the present invention provides a process, comprising combining a fluorovinyl ether functionalized aromatic diacid chloride with an aromatic diamine to form a reaction mixture, stirring said reaction mixture at a temperature between about −70° C. and the reflux temperature of said reaction mixture to form a polymer comprising repeat units having the structure (I), wherein the fluorovinyl ether functionalized aromatic diacid chloride is represented by the structure (III),

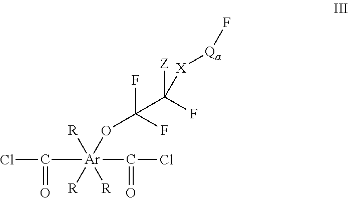

wherein,
Ar represents a benzene or naphthalene radical;
each R is independently H, C₁-C₁₀ alkyl, C₅-C₁₅ aryl, C₆-C₂₀ arylalkyl; OH, or a radical represented by the structure (II)

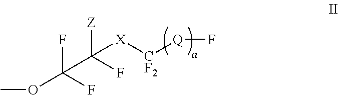

with the proviso that only one R can be OH or the radical represented by the structure (II);

### X is O or CF₂;

### Z is H, Cl, or Br;

a=0 or 1;
and,
Q is represented by the structure (Ia)

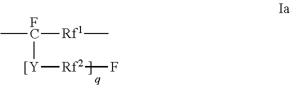

wherein q=0-10;
Y is O or CF₂;
Rf¹ is (CF₂)ₙ, wherein n is 0-10;
and,
Rf² is (CF₂)ₚ, wherein p is 0-10, with the proviso that when p is 0, Y is CF₂.

In another aspect, the invention provides a film comprising a polymer comprising a fluorovinyl ether functionalized aromatic repeat unit represented by the structure (I)

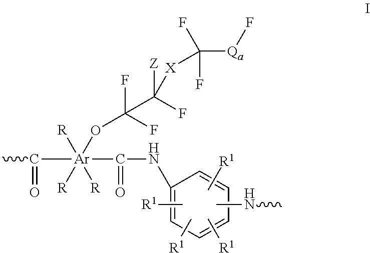

wherein,
Ar represents a benzene or naphthalene radical;
each R is independently H, C₁-C₁₀ alkyl, C₅-C₁₅ aryl, C₆-C₂₀ arylalkyl; OH, or a radical represented by the structure (II)

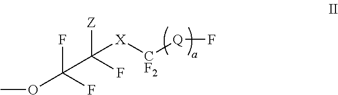

with the proviso that only one R can be OH or the radical represented by the structure (II);
Each R1 is independently H, C1-C10 alkyl, C5-C15 aryl, C6-C20 arylalkyl;

### X is O or CF₂;

### Z is H, Cl, or Br;

a=0 or 1;
and,
Q is represented by the structure (Ia)

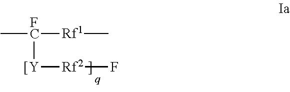

wherein q=0-10;
Y is O or CF₂;
Rf¹ is (CF₂)ₙ, wherein n is 0-10;
and,
Rf² is (CF₂)ₚ, wherein p is 0-10, with the proviso that when p is 0, Y is CF₂.

### DETAILED DESCRIPTION

When a range of values is provided herein, it is intended to encompass the end-points of the range unless specifically stated otherwise. Numerical values used herein have the precision of the number of significant figures provided, following the standard protocol in chemistry for significant figures as outlined in ASTM E29-08 Section 6. For example, the number 40 encompasses a range from 35.0 to 44.9, whereas the number 40.0 encompasses a range from 39.50 to 40.49.

The parameters n, p, and q as employed herein are each independently integers in the range of 1-10.

The term “fluorovinyl ether functionalized aromatic diester” refers to that subclass of compounds of structure (III) wherein R² is C₁-C₁₀ alkyl. The term “fluorovinyl ether functionalized aromatic diacid” refers to that subclass of compounds of structure (III) wherein R² is H. The term “perfluorovinyl compound” refers to the olefinically unsaturated compound represented by structure (VII), infra.

The term “copolymer” as used herein refers to a polymer comprising two or more chemically distinct repeat units, including dipolymers, terpolymers, tetrapolymers and the like. Also following conventional practice in the art, the term “homopolymer” refers to a polymer consisting of a plurality of repeat units that are chemically indistinguishable from one another.

In any chemical structure herein the presence of a terminal bond, shown as “—”, where no terminal chemical group is indicated, the terminal bond “—” indicates a radical. For example, —CH₃ represents a methyl radical.

In one aspect, the present invention provides a polymer comprising a fluorovinyl ether functionalized aromatic repeat unit represented by the structure (I).

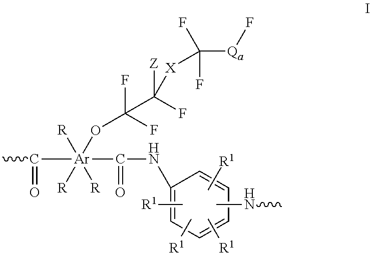

wherein,
Ar represents a benzene or naphthalene radical;
each R is independently H, C₁-C₁₀ alkyl, C₅-C₁₅ aryl, C₆-C₂₀ arylalkyl; OH, or a radical represented by the structure (II)

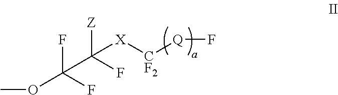

with the proviso that only one R can be OH or the radical represented by the structure (II);
Each R1 is independently H, C1-C10 alkyl, C5-C15 aryl, C6-C20 arylalkyl;

### X is O or CF₂;

### Z is H, Cl, or Br;

a=0 or 1;
and,
Q represents the structure (Ia)

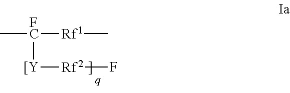

wherein q=0-10;
Y is O or CF₂;
Rf¹ is (CF₂)ₙ, wherein n is 0-10;
and,
Rf² is (CF₂)ₚ, wherein p is 0-10, with the proviso that when p is 0, Y is CF₂.

In one embodiment of the polymer, Ar is a benzene radical.

In one embodiment of the polymer, one R is OH.

In one embodiment of the polymer, each R is H.

In one embodiment of the polymer, one R is OH and the remaining two Rs are each H.

In one embodiment of the polymer, one R is represented by the structure (II) and the remaining two Rs are each H.

In one embodiment of the polymer, each R¹ is H.

In one embodiment of the polymer, X is O. In an alternative embodiment, X is CF₂.

In one embodiment of the polymer, Y is O. In an alternative embodiment, Y is CF₂.

In one embodiment of the polymer Z is Cl or Br. In a further embodiment, Z is Cl. In an alternative embodiment, one R is represented by the structure (II), and one Z is H. In a further embodiment, one R is represented by the structure (II), one Z is H, and one Z is Cl.

In one embodiment of the polymer, Rf¹ is CF₂.

In one embodiment of the polymer, Rf² is CF₂.

In one embodiment of the polymer, Rf² is a bond (that is, p=0), and Y is CF₂.

In one embodiment, a=0.

In one embodiment, a=1, q=0, and n=0.

In one embodiment of the polymer, Ar is a benzene radical, each R is H, Z is Cl, each R¹ is H, X is O, Y is O, Rf¹ is CF₂, and Rf² is perfluoropropenyl, and q=1.

In one embodiment of the polymer, the polymer is a homopolymer.

In one embodiment of the polymer, the polymer is a copolymer having repeat units made up of a plurality of embodiments of (I). In one embodiment the repeat unit represented by structure (I) is further represented by the structure (IVa)

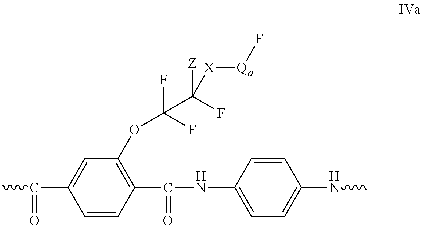

wherein Z, X, Q, and a are as stated supra.

In one embodiment the repeat unit represented by structure (I) is further represented by the structure (IVb)

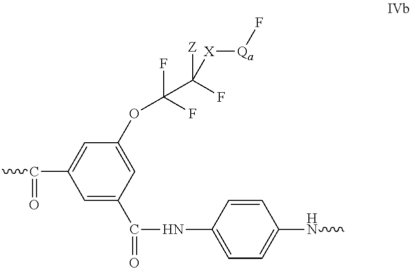

wherein Z, X, Q, and a are as stated supra.

In an alternative embodiment, the polymer is a copolymer comprising fluorovinyl ether functionalized aromatic repeat units represented by the structure (IVa) and fluorovinyl ether functionalized aromatic repeat units represented by the structure (IVb). In one embodiment, the copolymer is a random copolymer. In one embodiment, the copolymer is a block copolymer.

In another embodiment the polymer is a copolymer further comprising aramid repeat units represented by the structure (V),

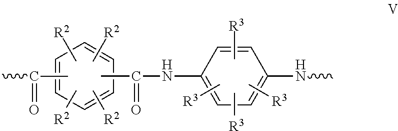

wherein each R² is independently H or alkyl, and each R³ is independently H or alkyl. In one embodiment, all the R²s are H, and all the R³s are H. In one embodiment, the repeat unit represented by structure (V) is a terephthalate radical. In an alternative embodiment, the repeat unit represented by the structure is an isophthalate radical.

In an alternative embodiment, the polymer is a copolymer further comprising terephthalate repeat units and isophthalate repeat units represented by the structure (V). In one embodiment, the copolymer is a random copolymer. In one embodiment, the copolymer is a block copolymer.

In another aspect, the present invention provides a process, comprising combining a fluorovinyl ether functionalized aromatic diacid chloride with an aromatic diamine to form a reaction mixture, heating to a temperature within the range of 180-240° C. followed by heating to 250-300° C., and, extracting volatiles by subjecting the mixture to evacuation; wherein the fluorovinyl ether functionalized aromatic diacid chloride is represented by the structure (III),

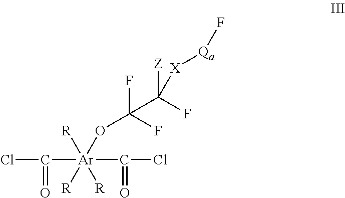

wherein,
Ar represents a benzene or naphthalene radical;
each R is independently H, C₁-C₁₀ alkyl, C₅-C₁₅ aryl, C₆-C₂₀ arylalkyl; OH, or a radical represented by the structure (II)

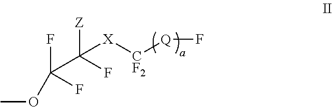

with the proviso that only one R can be OH or the radical represented by the structure (II);

### X is O or CF₂;

### Z is H, Cl, or Br;

a=0 or 1;
and,
Q represents the structure (Ia)

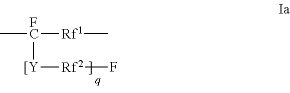

wherein q=0-10;
Y is O or CF₂;
Rf¹ is (CF₂)ₙ, wherein n is 0-10;
and,
Rf² is (CF₂)ₚ, wherein p is 0-10, with the proviso that when p is 0, Y is CF₂.

In one embodiment of the process, one R is OH.

In one embodiment of the process, each R is H.

In one embodiment of the process, one R is OH and the remaining two Rs are each H.

In one embodiment of the process, one R is represented by the structure (II) and the remaining two Rs are each H.

In one embodiment of the process, the aromatic diamine is 1,4-diaminobenzene.

In one embodiment of the process, X is O. In an alternative embodiment, X is CF₂.

In one embodiment of the process, Y is O. In an alternative embodiment, Y is CF₂.

In one embodiment of the process Z is Cl or Br. In a further embodiment, Z is Cl. In an alternative embodiment, one R is represented by the structure (II), and one Z is H. In a further embodiment, one R is represented by the structure (II), one Z is H, and one Z is Cl.

In one embodiment of the process, Rf¹ is CF₂

In one embodiment of the process, Rf² is CF₂.

In one embodiment of the process, Rf² is a bond (that is, p=0), and Y is CF₂.

In one embodiment, a=0.

In one embodiment, a=1, q=0, and n=0.

In one embodiment of the process, the aromatic diamine is 1,4-diaminobenzene, Ar is a benzene radical, each R is H, Z is Cl, X is O, Y is O, Rf¹ is CF₂, and Rf² is perfluoropropenyl, and q=1.

Aromatic diamines suitable for use in the present invention include but are not limited to 1,4-diaminobenzene, 1,3-diaminobenzene, or 2-(4-aminophenyl)-1H-benzo[d]imidazol-5-amine.

In one embodiment of the process, a mixture is formed by adding the ingredients recited supra to a reaction vessel, stirring the reaction mixture to form a polymer. The thus resulting polymer can be separated by vacuum distillation to remove the excess of amine.

In one embodiment the reaction mixture comprises more than one embodiment of the monomers encompassed in structure (III). In another embodiment the reaction mixture further comprises an aromatic diacid chloride represented by the structure (VI)

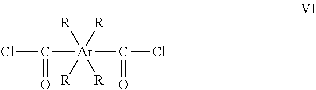

wherein Ar is an aromatic radical; each R is independently H or C₁-C₁₀ alkyl. In a further embodiment, each R is H. In one embodiment Ar is a benzene radical. In an alternative embodiment, Ar is a naphthalene radical.

Suitable aromatic diacid chlorides of structure (VI) are derived from the corresponding diacid by treatment of the diester with SO₂Cl, PCl₃, PCl₅, or oxalylchloride. Suitable aromatic diacids of structure (VI) include but are not limited to isophthalic acid, terephthalic acid, 2,6-naphthalene dicarboxylic acid, 4,4′-sulfonyl bisbenzoic acid, 4-sulfophthalic acid and biphenyl-4,4′-dicarboxylic acid. In one embodiment, the aromatic diacid is terephthallic acid. In an alternative embodiment, the aromatic diacid is isophthallic acid.

Suitable fluorovinyl ether functionalized aromatic diesters can be prepared by forming a reaction mixture comprising a hydroxy aromatic diester in the presence of a solvent and a catalyst with a perfluoro vinyl compound represented by the structure (VII)

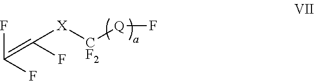

wherein X is O or CF₂, a=0 or 1; and, Q represents the structure (Ia)

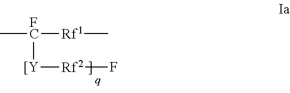

wherein q=0-10;
Y is O or CF₂;
Rf¹ is (CF₂)ₙ, wherein n is 0-10;
Rf² is (CF₂)ₚ, wherein p is 0-10, with the proviso that when p is 0, Y is CF₂.
   at a temperature between about −70° C. and the reflux temperature of the reaction mixture.

Preferably the reaction is conducted using agitation at a temperature above room temperature but below the reflux temperature of the reaction mixture. The reaction mixture is cooled following reaction.

When a halogenated solvent is employed, the group indicated as “Z” in the resulting fluorovinyl ether aromatic diester represented by structure (III) is the corresponding halogen. Suitable halogenated solvents include but are not limited to tetrachloromethane, tetrabromomethane, hexachloroethane and hexabromoethane. If the solvent is non-halogenated Z is H. Suitable non-halogenated solvents include but are not limited to tetrahydrofuran (THF), dioxane, and dimethylformamide (DMF).

The reaction is catalyzed by a base. A variety of basic catalysts can be used, i.e., any catalyst that is capable of deprotonating phenol. That is, a suitable catalyst is any catalyst having a pKa greater than that of phenol (9.95, using water at 25° C. as reference). Suitable catalysts include, but are not limited to, sodium methoxide, calcium hydride, sodium metal, potassium methoxide, potassium t-butoxide, potassium carbonate or sodium carbonate. Preferred are potassium t-butoxide, potassium carbonate, or sodium carbonate.

Reaction can be terminated at any desirable point by the addition of acid (such as, but not limited to, 10% HCl). Alternatively, when using solid catalysts, such as the carbonate catalysts, the reaction mixture can be filtered to remove the catalyst, thereby terminating the reaction.

Suitable hydroxy aromatic diesters include, but are not limited to, 1,4-dimethyl-2-hydroxy terephthalate, 1,4-diethyl-2-5-dihydroxy terephthalate, 1,3-dimethyl 4-hydroxyisophthalate, 1,3-dimethyl-5-hydroxy isophthalate, 1,3-dimethyl 2-hydroxyisophthalate, 1,3-dimethyl 2,5-dihydroxyisophthalate, 1,3-dimethyl 2,4-dihydroxyisophthalate, dimethyl 3-hydroxyphthalate, dimethyl 4-hydroxyphthalate, dimethyl 3,4-dihydroxyphthalate, dimethyl 4,5-dihydroxyphthalate, dimethyl 3,6-dihydroxyphthalate, dimethyl 4,8-dihydroxynaphthalene-1,5-dicarboxylate, dimethyl 3,7-dihydroxynaphthalene-1,5-dicarboxylate, dimethyl 2,6-dihydroxynaphthalene-1,5-dicarboxylate, or mixtures thereof.

Suitable perfluorovinyl compounds include, but are not limited to, 1,1,1,2,2,3,3-heptafluoro-3-(1,1,1,2,3,3-hexafluoro-3-(1,2,2-trifluorovinyloxy)propan-2-yloxy)propane, heptafluoropropyltrifluorovinylether, perfluoropent-1-ene, perfluorohex-1-ene, perfluorohept-1-ene, perfluorooct-1-ene, perfluoronon-1-ene, perfluorodec-1-ene, and mixtures thereof.

To prepare a suitable fluorovinyl ether functionalized aromatic diester a suitable hydroxy aromatic diester and a suitable perfluovinyl compound are combined in the presence of a suitable solvent and a suitable catalyst until the reaction has achieved the desired degree of conversion. The reaction can be continued until no further product is produced over some preselected time scale. The required reaction time to achieve the desired degree of conversion depends upon the reaction temperature, the chemical reactivity of the specific reaction mixture components, and the degree of mixing applied to the reaction mixture. Progress of the reaction can be monitored using any one of a variety of established analytical methods, including, but not limited to, nuclear magnetic resonance spectroscopy, thin layer chromatography, and gas chromatography.

When the desired level of conversion has been achieved, the reaction mixture is quenched, as described supra. The thus quenched reaction mixture can be concentrated under vacuum, and rinsed with a solvent. Under some circumstances, a plurality of compounds encompassed by the structure (III) can be made in a single reaction mixture. In such cases, separation of the products thus produced can be effected by any method known to the skilled artisan such as, but not limited to, distillation or column chromatography.

To prepare the corresponding diacid from the so-formed diester, the thus produced fluorovinyl ether functionalized aromatic diester can be contacted with an aqueous base, preferably a strong base such as KOH or NaOH, at reflux, followed by cooling to room temperature, followed by acidifying the mixture, preferably with a strong acid, such as HCl or H₂SO₄, until the pH is within the range of 0 to 2. Preferably pH is 1. The acidification thus performed causes the precipitation of the fluorovinyl ether functionalized aromatic diacid. The thus precipitated diacid can then be isolated via filtration, redissolved in a solvent such as ethyl acetate, and then recrystallized. The progress of the reaction can be followed by any convenient method, including but not limited to thin layer chromatography, gas chromatography and NMR.

Once the fluorovinyl ether aromatic diacid has been prepared, it is suitable for conversion to the corresponding diacid chloride, as described supra.

In another aspect the invention provides a film of a polymer comprising a fluorovinyl ether functionalized aromatic repeat unit represented by the structure (I)

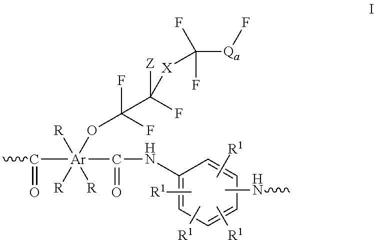

wherein,
Ar represents a benzene or naphthalene radical;
each R is independently H, C₁-C₁₀ alkyl, C₅-C₁₅ aryl, C₆-C₂₀ arylalkyl; OH, or a radical represented by the structure (II)

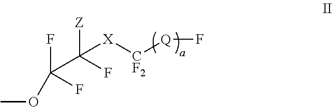

with the proviso that only one R can be OH or the radical represented by the structure (II);
Each R1 is independently H, C1-C10 alkyl, C5-C15 aryl, C6-C20 arylalkyl;

### X is O or CF₂;

### Z is H, Cl, or Br;

a=0 or 1;
and,
Q represents the structure (Ia)

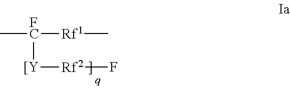

wherein q=0-10;
Y is O or CF₂;
Rf¹ is (CF₂)ₙ, wherein n is 0-10;
and,
Rf² is (CF₂)ₚ, wherein p is 0-10, with the proviso that when p is 0, Y is CF₂.

One embodiment provides a polyaramid film that exhibits reduced surface energy vis a vis polyaramids that do not contain the fluorovinylether moiety of the film. For example, the literature value for the surface energy of Kevlar® Polyaramid available from the DuPont Company is 44 dyne/cm whereas, as shown in Example 11 infra, films exhibited surface energy well below 30 dyne/cm.

The invention is further described but not limited by the following specific embodiments.

### EXAMPLES

The following chemicals and reagents were used as received from Sigma-Aldrich, Milwaukee, Wis.:
potassium t-butoxide
dimethyl 5-hydroxyisophthalate
tetrahydrofuran
dimethyl formamide
dichloromethane
hexane
tetrachloromethane
anhydrous sodium sulfate
carbon tetrabromide (tetrabromomethane)
hydrochloric acid (HCl)
1,4-dimethyl-2-hydroxy terephthalate
potassium hydroxide (KOH)
ethyl acetate
thionyl chloride
2-(4-aminophenyl)-1H-benzo[d]imidazol-5-amine
para-phenylene diamine
meta-phenylene diamine
   The following chemicals were used as received from SynQuest Labs., Alachua, Fla.:
1,1,1,2,2,3,3-heptafluoro-3-(1,1,1,2,3,3-hexafluoro-3-(1,2,2-trifluorovinyloxy)propan-2-yloxy)propane
Heptafluoropropyltrifluorovinylether

### Preparation of Dimethyl 5-(1,1,2-trifluoro-2-(1,1,2,3,3,3-hexafluoro-2-(perfluoropropoxy)propoxy)ethoxy)isophthalate

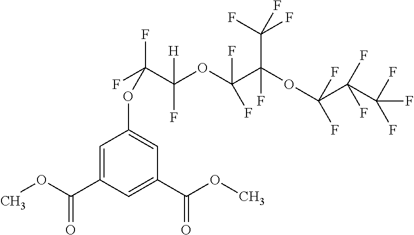

A reaction mixture was prepared in a dry box by combining tetrahydrofuran (THF, 1000 mL) and dimethyl 5-hydroxyisophthalate (42.00 g, 0.20 mol) in an oven-dried round bottom reaction flask equipped with a stirrer. Potassium t-butoxide (6.16 g, 0.055 mol) was added to the flask. 1,1,1,2,2,3,3-Heptafluoro-3-(1,1,1,2,3,3-hexafluoro-3-(1,2,2-trifluorovinyloxy)propan-2-yloxy)propane (216 g, 0.50 mol) was then added via an addition funnel to the reaction mixture, and the mixture was stirred at room temperature. After 24 hours the reaction was terminated via the addition of 80 mL of 10% HCl. The resulting mixture was concentrated at reduced pressure, diluted with dichloromethane, washed with 10% HCl (2×100 mL) and then with water (2×100 mL), to form an aqueous phase and an organic phase. The organic phase was separated and then dried over anhydrous sodium sulfate, followed by concentration at reduced pressure to form a crude product. The crude product was purified by column chromatography to give 86.07 g (67.32%) yield of the desired material, dimethyl 5-(1,1,2-trifluoro-2-(1,1,2,3,3,3-hexafluoro-2-(perfluoropropoxy)propoxy)ethoxy)isophthalate.

### Preparation of dimethyl 2-(1,1,2-trifluoro-2-(1,1,2,3,3,3-hexafluoro-2-(perfluoropropoxy)propoxy)ethoxy)terephthalate

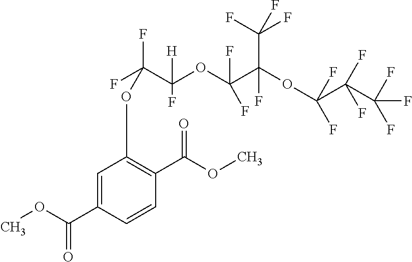

In a dry box, Tetrahydrofuran (THF, 288 mL) was combined with 1,4-dimethyl-2-hydroxy terephthalate (30.25 g, 0.144 mol) in an oven-dried multiple neck 500 mL reaction flask equipped with a stirring bar and a pressure equaling (PE) addition funnel. The mixture so formed was stirred until a homogeneous solution resulted. Potassium t-butoxide (4.435 g, 0.040 mol) was then added, resulting in a heterogeneous mixture. Via the PE funnel, 1,1,1,2,2,3,3-heptafluoro-3-(1,1,1,2,3,3-hexafluoro-3-(1,2,2-trifluorovinyloxy)propan-2-yloxy)propane (155.52 g, 0.36 mol) was then added resulting to form a reaction mixture. The reaction mixture was stirred at room temperature (approximately 25° C.) for ˜40 hours. The resulting mixture was quenched by the addition of 5 mL of 10% HCl. The product in the reaction flask was concentrated at reduced pressure, and then dissolved in dichloromethane (˜300 mL) followed by washing with 10% HCl (2×75 mL) and after that, with water (˜75 mL), yielding an organic and an aqueous phase. The separated organic phase was then dried over anhydrous sodium sulfate. The sodium sulfate was then filtered off and the resulting material concentrated at reduced pressure and then fractionally vacuum distilled. The fractions boiling between 134-136° C. at 1.4-1.1 torr (84.55 g, 91.4% yield) and 136-138 at 1.1 torr (3.35 g) (combined yield: 95.04%) were collected. NMRs (nuclear magnetic resonance) of these samples were consistent with dimethyl 2-(1,1,2-trifluoro-2-(1,1,2,3,3,3-hexafluoro-2-(perfluoropropoxy)propoxy)ethoxy)terephthalate.

### Preparation of Dimethyl 2-(2-chloro-1,1,2-trifluoro-2-(1,1,2,3,3,3-hexafluoro-2-perfluoropropoxy)propoxy)ethoxy)terephthalate

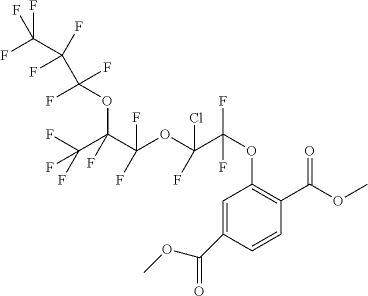

In a dry box, dimethyl formamide (DMF, 10.0 mL) and tetrachloromethane (50 mL) were combined with 1,4-dimethyl-2-hydroxy terephthalate (1.05 g, 0.005 mol) in an oven-dried 100 mL reaction flask equipped with a stirring bar and a pressure equaling (PE) addition funnel. The mixture so formed was then stirred until a homogeneous solution resulted. Potassium t-butoxide (0.154 g, 0.001375 mol) was added to the reaction flask, resulting in a heterogeneous mixture. Via the PE funne, 1,1,1,2,2,3,3-heptafluoro-3-(1,1,1,2,3,3-hexafluoro-3-(1,2,2-trifluorovinyloxy)propan-2-yloxy)propane (5.40 g, 0.0125 mol) was added to form a reaction mixture. The reaction mixture was stirred at room temperature (about 25° C.) for ˜24 hours. The reaction was quenched by the addition for 2 mL of 10% HCl. The resulting mixture was concentrated at reduced pressure, followed by dissolution in dichloromethane (˜150 mL). The thus prepared solution was then washed with 10% HCl (2×25 mL) followed by water washing (˜25 mL) to form an organic phase and an aqueous phase. The separated organic phase was then dried over anhydrous sodium sulfate. The sodium sulfate was then filtered off and the filtrate concentrated at reduced pressure to produce a crude product. NMR of the crude product was consistent with high purity of the desired material, dimethyl 2-(2-chloro-1,1,2-trifluoro-2-(1,1,2,3,3,3-hexafluoro-2-perfluoropropoxy)propoxy)ethoxy)terephthalate, with a small amount of dimethyl formamide present. The crude material was then purified by column chromatography (R_{f} 0.50 dichloromethane (1)/Hexane (1)) to give the purified dimethyl 2-(2-chloro-1,1,2-trifluoro-2-(1,1,2,3,3,3-hexafluoro-2-perfluoropropoxy)propoxy)ethoxy)terephthalate, as a clear oil, 2.60 g (76.92% yield).

### Preparation of Dimethyl 2-(2-bromo-1,1,2-trifluoro-2-(Perfluoropropoxy)ethoxy)terephthalate

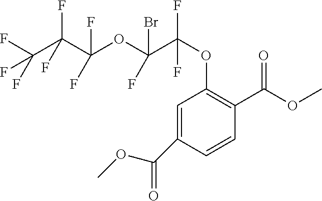

In a dry box, dimethyl formamide (20.0 mL) and carbon tetrabromide (12.5 g) were combined with 1,4-dimethyl-2-hydroxy terephthalate (1.05 g, 0.005 mol) in an oven-dried 100 mL reaction flask equipped with a stirring bar and a pressure equaling (PE) addition funnel. The mixture so-prepared was stirred until a homogeneous solution resulted. Potassium t-butoxide (0.154 g, 0.001375 mol) was then added to the reaction flask, resulting in a heterogeneous mixture. Via the PE funnel, heptafluoropropyltrifluorovinylether (3.325 g, 0.0125 mol) was added to produce a reaction mixture. The thus prepared reaction mixture was stirred at room temperature (about 25° C.) for ˜24 hours. The reaction was quenched by the addition of 2 mL of 10% HCl. The resulting mixture was concentrated at reduced pressure, and then dissolved in dichloromethane (˜150 mL) followed by washing with 10% HCl (2×25 mL) and then with water (˜25 mL) to form an organic phase and an aqueous phase. The separated organic phase was then dried over anhydrous sodium sulfate. The sodium sulfate was then filtered off and the filtrate concentrated at reduced pressure to form a crude product. NMR of the crude product was consistent with high purity of dimethyl 2-(2-bromo-1,1,2-trifluoro-2-(perfluoropropoxy)ethoxy)terephthalate, with small amounts of dimethyl formamide and carbon tetrabromide present. The crude product was then purified by column chromatography to give the purified product, dimethyl 2-(2-bromo-1,1,2-trifluoro-2-(perfluoropropoxy)ethoxy)terephthalate, as a clear oil, 2.280 g (82.31% yield).

### Preparation of 2-(1,1,2-trifluoro-2-(1,1,2,3,3,3-hexafluoro-2-(perfluoropropoxy)propoxy)ethoxy)terephthalic acid

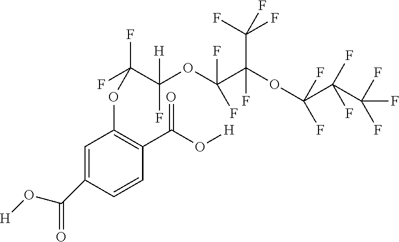

Dimethyl 2-(1,1,2-trifluoro-2-(1,1,2,3,3,3-hexafluoro-2-(perfluoropropoxy)-propoxy)ethoxy)terephthalate (2.25 g, 0.035 mol) was added to a solution of water (50 mL) and potassium hydroxide (KOH, 1.96 g) in a reaction flask. The resulting solution in the reaction flask was heated for 5 hours, cooled to room temperature (about 25° C.) and then acidified by adding concentrated HCl to the reaction flask until a pH of ˜1 was achieved accompanied by the formation of a precipitate in the reaction flask. The precipitate was filtered and dried under vacuum. Proton NMR of this precipitate was consistent with 2-(1,1,2-trifluoro-2-(1,1,2,3,3,3-hexafluoro-2-(perfluoropropoxy)propoxy)ethoxy)terephthalic acid. The precipitate was then crystallized from ethyl acetate (EtOAc, ˜1 part) and hexane (˜4 parts). After filtration and drying under vacuum, the resulting white di-acid, 2-(1,1,2-trifluoro-2-(1,1,2,3,3,3-hexafluoro-2-(perfluoropropoxy)propoxy)ethoxy)terephthalic acid, had a melting point of 236-239° C.

### Preparation of 2-(2-chloro-1,1,2-trifluoro-2-(1,1,2,3,3,3-hexafluoro-2-(perfluoropropoxy)propoxy)ethoxy)terephthalic acid

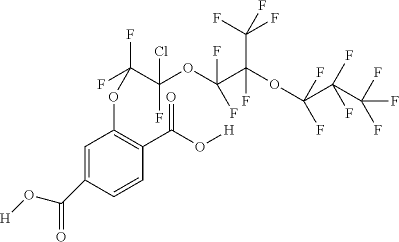

Dimethyl 2-(2-chloro-1,1,2-trifluoro-2-(1,1,2,3,3,3-hexafluoro-2-(perfluoropropoxy)propoxy)ethoxy)terephthalate (10.00 g, 0.0148 mol) was added to a solution of water (100 mL) and potassium hydroxide (KOH, 8.0 g) in a reaction flask. The resulting solution in the reaction flask was heated to reflux overnight, cooled to room temperature (about 25° C.) and then acidified by adding concentrated HCl to the reaction flask to achieve a pH of ˜1 accompanied by the formation of a precipitate in the reaction flask. The precipitate was filtered and dried under vacuum. NMR of this precipitate was consistent with 2-(2-chloro-1,1,2-trifluoro-2-(1,1,2,3,3,3-hexafluoro-2-(perfluoropropoxy)propoxy)ethoxy)terephthalic acid.

### Preparation of 2-(2-bromo-1,1,2-trifluoro-2-(1,1,2,3,3,3-hexafluoro-2-(perfluoropropoxy)propoxy)ethoxy)terephthalic acid

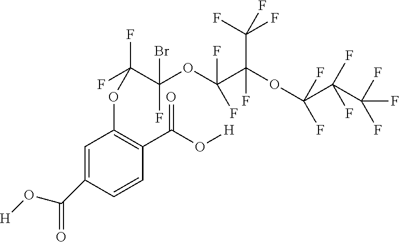

Dimethyl 2-(2-bromo-1,1,2-trifluoro-2-(1,1,2,3,3,3-hexafluoro-2-(perfluoropropoxy)propoxy)ethoxy)terephthalate (10.9 g, 0.15 mol) was added to a solution of water (100 mL) and potassium hydroxide (KOH, 8.0 g) in a reaction flask. The resulting solution in the reaction flask was heated to reflux overnight, cooled to room temperature (about 25° C.) and then acidified by addition of concentrated HCl to the reaction flask until a pH of ˜1 was achieved accompanied by the formation of a precipitate. The precipitate was filtered and dried under vacuum, yielding 10.90 g. NMRs (proton and carbon) of this material was consistent with 2-(2-bromo-1,1,2-trifluoro-2-(1,1,2,3,3,3-hexafluoro-2-(perfluoropropoxy)propoxy)ethoxy)terephthalic acid.

### Preparation of 2-(1,1,2-trifluoro-2-(1,1,2,3,3,3-hexafluoro-2-(perfluoropropoxy)propoxy)ethoxy)terephthaloyl dichloride

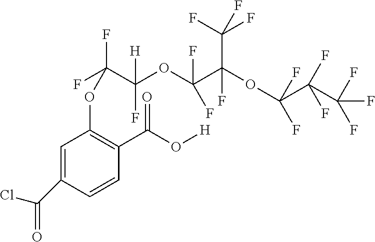

2-(1,1,2-Trifluoro-2-(1,1,2,3,3,3-hexafluoro-2-(perfluoropropoxy)-propoxy)ethoxy)terephthalic acid (1.129 g) was placed in a round bottom reaction flask equipped with a reflux condenser, stirrer and kept under nitrogen. Thionyl chloride (5.8 mL) was added to the reaction flask and the reaction solution heated to a gentle reflux overnight. The resulting solution was cooled to room temperature (about 25° C.) and the excess thionyl chloride was removed by vacuum. NMR was consistent with 2-(1,1,2-trifluoro-2-(1,1,2,3,3,3-hexafluoro-2-(perfluoropropoxy)propoxy)ethoxy)terephthaloyl dichloride. The product was an oil.

### Preparation of 2-(2-chloro-1,1,2-trifluoro-2-(perfluoropropoxy)ethoxy)terephthaloyl dichloride

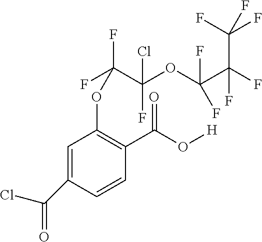

2-(2-chloro-1,1,2-trifluoro-2-(perfluoropropoxy)ethoxy)terephthalic acid (50.99 g, 0.1056 mol) was place in an oven-dried round bottom reaction flask equipped with a stirrer, reflux condenser and kept under nitrogen to form a reaction mixture. Thionyl chloride (423 mL) was added to the reaction flask and the resulting reaction mixture was heated to reflux over night. The resulting mixture was cooled to room temperature and the excess thionyl chloride was removed under vacuum. The resulting material was then purified by vacuum distillation. NMR was consistent with 2-(2-chloro-1,1,2-trifluoro-2-(perfluoropropoxy)ethoxy)terephthaloyl dichloride, 46.04 g, 74.5% yield, with a boiling point 124-126° C. at 1.1 torr.

### Preparation of 5-(1,1,2-trifluoro-2-(1,1,2,3,3,3-hexafluoro-2-(perfluoropropoxy)propoxy)ethoxy)isophthaloyl dichloride

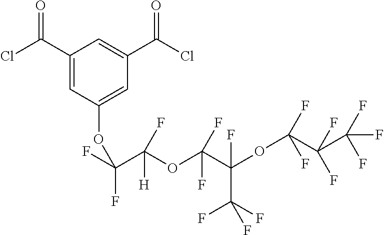

5-(1,1,2-Trifluoro-2-(1,1,2,3,3,3-hexafluoro-2-(perfluoropropoxy)propoxy)ethoxy)isophthalic acid (46.63 g, 0.076 mol) was placed in an oven-dried round bottom reaction flask equipped with a stirrer, reflux condenser and kept under nitrogen. Thionyl chloride (304 mL) was added to the flask to form a reaction mixture, and the thus prepared reaction mixture was heated to reflux over night. The resulting mixture was cooled to room temperature (about 25° C.) and the excess thionyl chloride was removed from the mixture under vacuum, forming a reaction product. The resulting product was then vacuum distilled to purify the product: 5-(1,1,2-trifluoro-2-(1,1,2,3,3,3-hexafluoro-2-(perfluoropropoxy)propoxy)ethoxy)isophthaloyl dichloride, 38.96 g, 78.8% yield, with a boiling point of 116-123° C. at 0.60 torr.

### Preparation of 2-(2-bromo-1,1,2-trifluoro-2-(1,1,2,3,3,3-hexafluoro-2-(perfluoropropoxy)propoxy)ethoxy)terephthaloyl dichloride ((A) ˜87%) and 2-(1,1,2-trifluoro-2-(1,1,2,3,3,3-hexafluoro-2-(perfluoropropoxy)propoxy)ethoxy)terephthaloyl dichloride ((B) ˜13%)

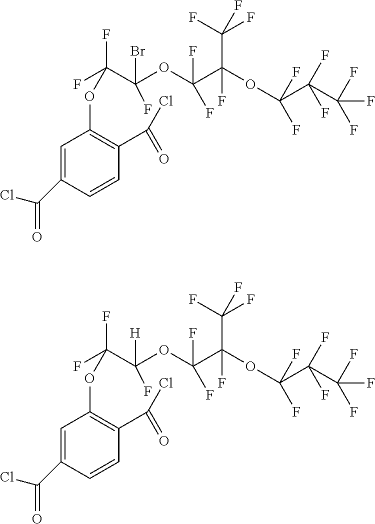

2-(2-bromo-1,1,2-trifluoro-2-(1,1,2,3,3,3-hexafluoro-2-(perfluoropropoxy)propoxy)ethoxy)terephthalic acid (57.70 g) containing ˜13% of the 2-(1,1,2-trifluoro-2-(1,1,2,3,3,3-hexafluoro-2-(perfluoropropoxy)propoxy)ethoxy)terephthalic acid was place in an oven-dried round bottom reaction flask equipped with a stirrer, reflux condenser and kept under nitrogen to form a reaction mixture. Thionyl chloride (334 mL) was added to the flask to form a reaction mixture. The so formed reaction mixture was heated to reflux over night. The resulting mixture was cooled to room temperature (about 25° C.) and the excess thionyl chloride was removed from the mixture under vacuum to form a reaction product. The resulting product was then vacuum distilled to give a product: 38.96 g, 78.8% yield, with a boiling point of 150-165° C. at ˜0.30 torr. Proton NMR was consistent with a mixture of 2-(2-bromo-1,1,2-trifluoro-2-(1,1,2,3,3,3-hexafluoro-2-(perfluoropropoxy)propoxy)ethoxy)terephthaloyl dichloride (˜87%) and 2-(1,1,2-trifluoro-2-(1,1,2,3,3,3-hexafluoro-2-(perfluoropropoxy)propoxy)ethoxy)terephthaloyl dichloride.

### Example 1

### Polymerization of m-Phenylene diamine with 2-(2-bromo-1,1,2-trifluoro-2-(1,1,2,3,3,3-hexafluoro-2-(perfluoropropoxy)-propoxy)ethoxy)terephthaloyl dichloride

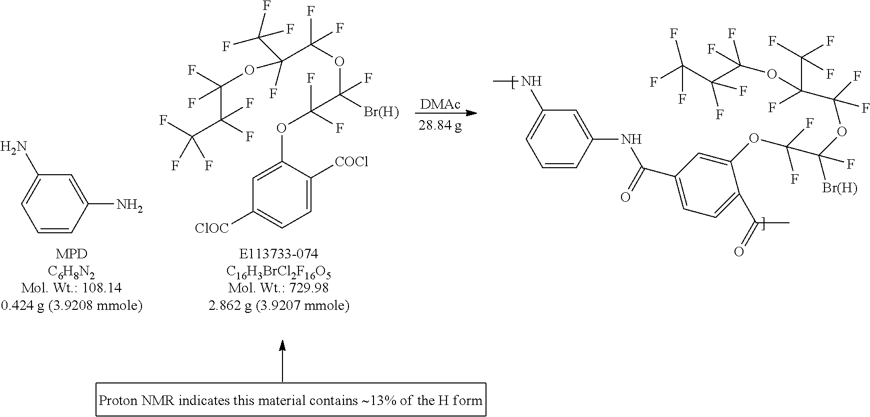

m-Phenylene diamine (0.424, 3.9208 mmol) was added to an oven-dried reaction vial containing dimethyl acetamide (28.84 g) to form a solution. The solution was cooled, then 2-(2-bromo-1,1,2-trifluoro-2-(1,1,2,3,3,3-hexafluoro-2-(perfluoropropoxy)-propoxy)ethoxy)terephthaloyl dichloride (2.862 g, 3.9208 mmol) (note, via NMR this acid chloride contain ˜13% 2-(1,1,2,3,3,4,4,5,5,6,6,7,7,8,8,8-hexadecafluorooctyloxy)terephthaloyl dichloride) was added to the reaction vial and stirred rapidly to form a reaction mixture. The solution exhibited a light color which appeared and then disappeared in the reaction vial. After 4 hours the resulting homogeneous solution was poured into a Waring blender containing ˜150 mL of water, and a white fibrous material was formed. The resulting white fibrous material was dried under vacuum. Proton NMR of the resulting material showed the characteristic two amide protons of the resulting poly-aramid, a polymer of m-Phenylene diamine with 2-(2-bromo-1,1,2-trifluoro-2-(1,1,2,3,3,3-hexafluoro-2-(perfluoropropoxy)-propoxy)ethoxy)terephthaloyl dichloride.

### Example 2

### Polymerization of p-Phenylene diamine with 2-(2-bromo-1,1,2-trifluoro-2-(1,1,2,3,3,3-hexafluoro-2-(perfluoropropoxy)-propoxy)ethoxy)terephthaloyl dichloride

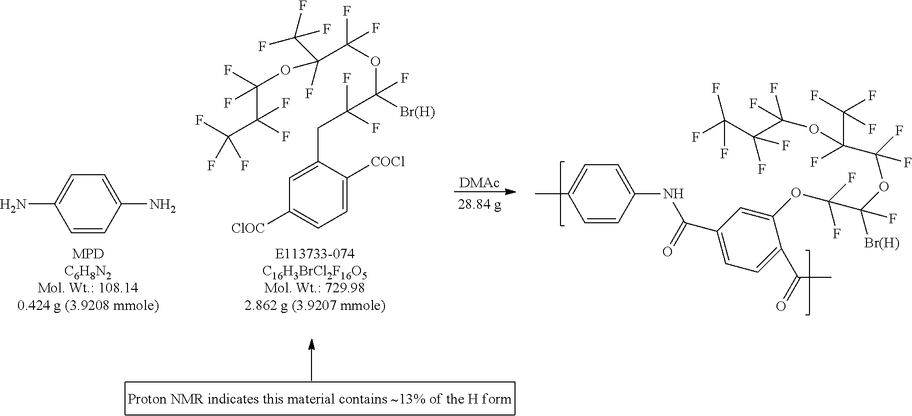

p-Phenylene diamine (0.424, 3.9208 mmol) was added to an oven reaction vial containing dimethyl acetamide (28.84 g) to form a solution. This solution was cooled, then 2-(2-bromo-1,1,2-trifluoro-2-(1,1,2,3,3,3-hexafluoro-2-(perfluoropropoxy)-propoxy)ethoxy)terephthaloyl dichloride (2.862 g, 3.9208 mmol) (note, via NMR this acid chloride contain ˜13% 2-(1,1,2,3,3,4,4,5,5,6,6,7,7,8,8,8-hexadecafluorooctyloxy)terephthaloyl dichloride) was added to the vial and stirred rapidly to form a reaction mixture. The resulting solution exhibited a light color which appeared and then disappeared in the reaction vial. After 4 hours the resulting viscous solution was poured into a Waring blender containing ˜150 mL of water, and an off-white solid product was formed. The resulting off white solid product was dried under vacuum. The product was identified as a polymer of p-phenylene diamine with 2-(2-bromo-1,1,2-trifluoro-2-(1,1,2,3,3,3-hexafluoro-2-(perfluoropropoxy)-propoxy)ethoxy)terephthaloyl dichloride.

### Example 3

### Aramid co-polymer with 2-(4-aminophenyl)-1H-benzo[d]imidazol-5-amine with para-phenylene diamine

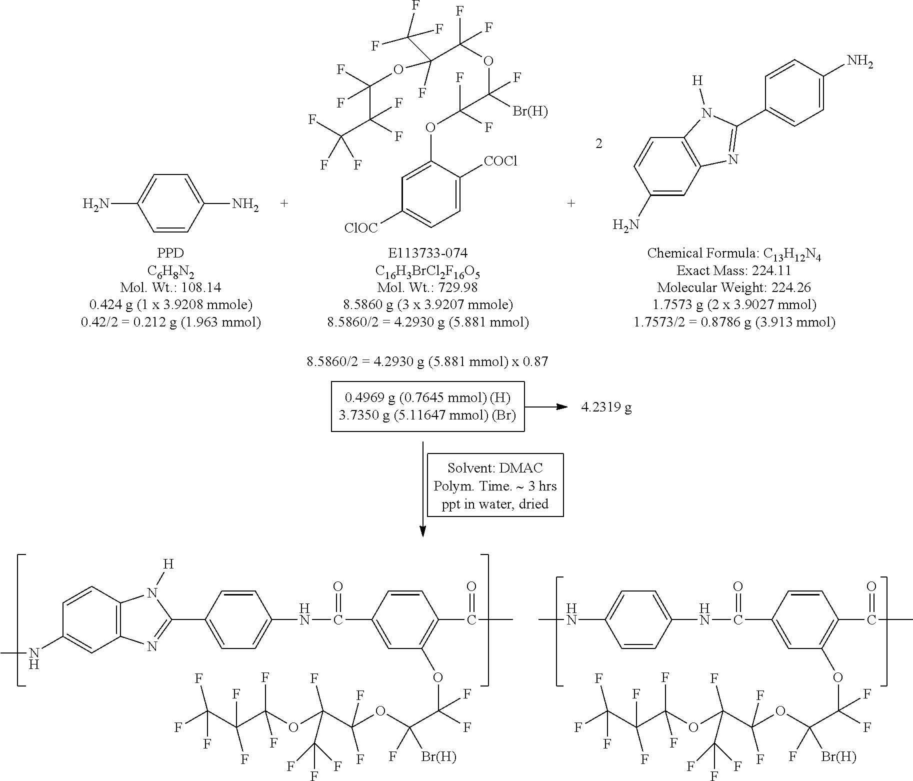

In a flask, 2-(4-aminophenyl)-1H-benzo[d]imidazol-5-amine (0.8766 g, 3.913 mmol) and para-phenylene diamine (0.212 g, 1.963 mmol) were dissolved in DMAC (˜100 mL) at room temperature to form a solution. A reaction mixture was formed by the addition to the solution so prepared 2-(2-bromo-1,1,2-trifluoro-2-(1,1,2,3,3,3-hexafluoro-2-(perfluoropropoxy)-propoxy)ethoxy)terephthaloyl dichloride (2.862 g, 3.9208 mmol) (note, via NMR this acid chloride contain ˜13% 2-(1,1,2,3,3,4,4,5,5,6,6,7,7,8,8,8-hexadecafluorooctyloxy)terephthaloyl dichloride) (4.2319 g). The reaction mixture was stirred overnight at room temperature (about 25° C.). The reaction mixture was then poured into a Waring blender containing ˜200 mL of water, and a polymer precipitate was then formed. This precipitated polymer was washed with additional water and dried under vacuum giving ˜4.5 g of polymer product. The product was identified as an aramid co-polymer with 2-(4-aminophenyl)-1H-benzo[d]imidazol-5-amine with para-phenylene diamine.

### Example 4

### Aramid co-polymer with 2-(4-aminophenyl)-1H-benzo[d]imidazol-5-amine and meta-phenylene diamine

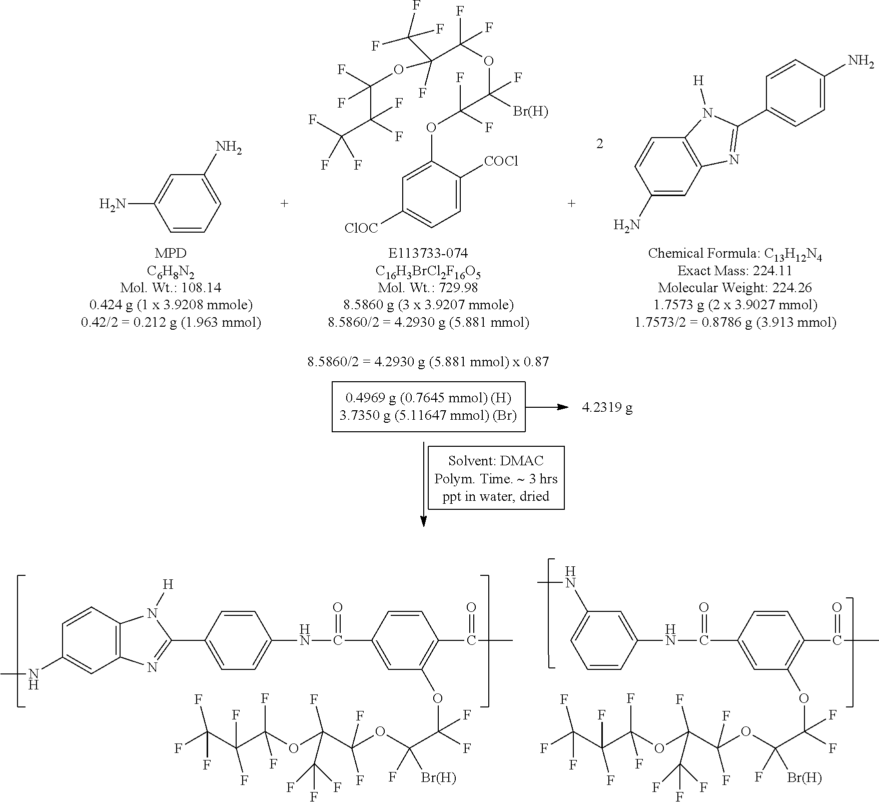

In a flask, 2-(4-aminophenyl)-1H-benzo[d]imidazol-5-amine (0.8766 g, 3.913 mmol) and meta-phenylene diamine (0.212 g 1.963 mmol) were dissolved in DMAC (˜100 mL) at room temperature forming a solution. A reaction mixture was prepared by addition to the solution so formed of 2-(2-bromo-1,1,2-trifluoro-2-(1,1,2,3,3,3-hexafluoro-2-(perfluoropropoxy)-propoxy)ethoxy)terephthaloyl dichloride (2.862 g, 3.9208 mmol) (note, via NMR this acid chloride contain ˜13% 2-(1,1,2,3,3,4,4,5,5,6,6,7,7,8,8,8-hexadecafluorooctyloxy)terephthaloyl dichloride) (4.2319 g). The resulting reaction mixture was stirred overnight at room temperature (about 25° C.). The reaction mixture was then poured into a Waring blender containing ˜200 mL of water and a polymer precipitate formed. The precipitated polymer was washed with additional water and dried under vacuum, giving ˜5.45 g of aramid co-polymer of 2-(4-aminophenyl)-1H-benzo[d]imidazol-5-amine and meta-phenylene diamine.

### Example 5

### Aramid

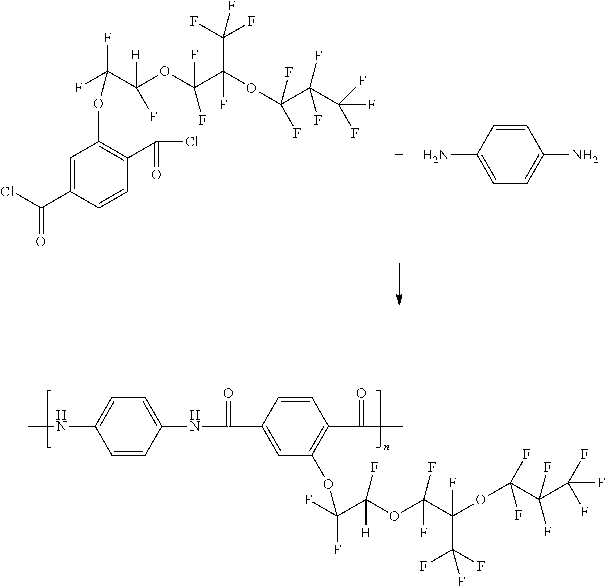

Para-phenylene diamine (1.08 g, 0.01 mol) was placed in an oven-dried 250 mL reaction flask equipped with a mechanical stirrer in a dry box. To this solution in the reaction flask was added 2-(1,1,2-trifluoro-2-(1,1,2,3,3,3-hexafluoro-2-(perfluoropropoxy)propoxy)ethoxy)terephthaloyl dichloride (6.66 g, 0.01023 mol), forming a reaction solution. The resulting reaction solution was stirred overnight at room temperature (about 25° C.) and then the resulting polymer precipitated in water. The resulting polymer was washed with additional water and then dried under vacuum at 60° C.

### Example 6

### Aramid

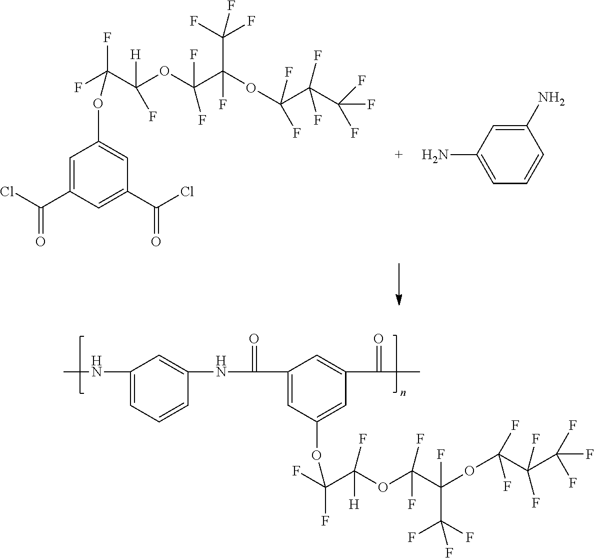

Meta-phenylene diamine (1.08 g, 0.01 mol) was placed in an oven-dried 250 mL reaction flask equipped with a mechanical stirrer in the dry box. To this solution was added 5-(1,1,2-trifluoro-2-(1,1,2,3,3,3-hexafluoro-2-(perfluoropropoxy)propoxy)ethoxy)isophthaloyl dichloride (6.66 g, 0.01023 mol) to form a reaction solution. The resulting reaction solution was stirred overnight at room temperature (about 25° C.) and then the resulting polymer precipitated in water. The resulting polymer was washed with additional water and then dried under vacuum at 60° C.

### Example 7

### Aramid

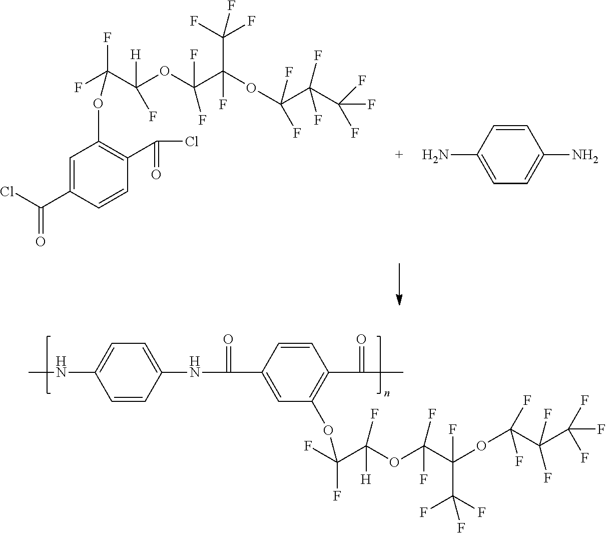

Para-phenylene diamine (1.08 g, 0.01 mol) was placed in an oven-dried 250 mL reaction flask equipped with a mechanical stirrer in a dry box. To this reaction solution was added 2-(1,1,2-trifluoro-2-(1,1,2,3,3,3-hexafluoro-2-(perfluoropropoxy)propoxy)ethoxy)terephthaloyl dichloride (6.66 g, 0.01023 mol) to form a reaction solution. The resulting reaction solution was stirred overnight at room temperature (about 25° C.) and then the resulting polymer precipitated in water. The resulting polymer was washed with additional water and then dried under vacuum at 60° C.

### Example 8

### Aramid

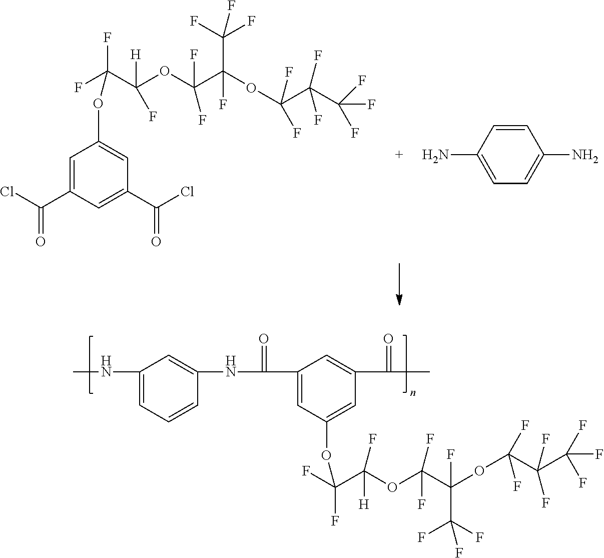

Para-phenylene diamine (1.08 g, 0.01 mol) was placed in an oven-dried 250 mL reaction flask equipped with a mechanical stirrer in a dry box. To this solution was added 5-(1,1,2-trifluoro-2-(1,1,2,3,3,3-hexafluoro-2-(perfluoropropoxy)propoxy)ethoxy)isophthaloyl dichloride (6.66 g, 0.01023 mol) to form a reaction solution. The reaction solution was stirred overnight at room temperature (about 25°) and then the resulting polymer precipitated in water. The resulting polymer was washed with additional water and then dried under vacuum at 60° C.

### Example 9

### Aramid

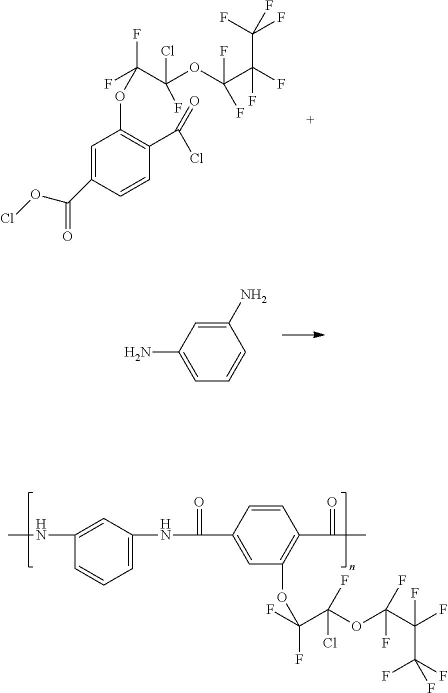

Meta-phenylene diamine (1.08 g, 0.01 mol) was placed in an oven-dried 250 mL reaction flask equipped with a mechanical stirrer in the dry box. To this solution was added 2-(2-chloro-1,1,2-trifluoro-2-(perfluoropropoxy)ethoxy)terephthaloyl dichloride (5.19 g, 0.010 mol) to form a reaction solution. The resulting reaction solution was stirred overnight at room temperature (about 25° C.) and then the resulting polymer precipitated in water. The resulting polymer was washed with additional water and then dried under vacuum at 60° C.

### Example 10

### Aramid

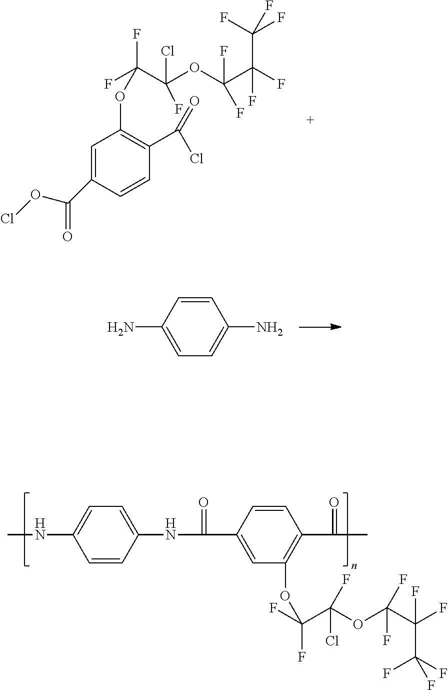

Para-phenylene diamine (1.08 g, 0.01 mol) was placed in an oven-dried 250 mL reaction flask equipped with a mechanical stirrer in the dry box. To this solution was added 2-(2-chloro-1,1,2-trifluoro-2-(perfluoropropoxy)ethoxy)terephthaloyl dichloride (5.19 g, 0.010 mol) to form a reaction solution. The resulting reaction solution was stirred overnight at room temperature (about 25°) and then the resulting polymer precipitated in water. The resulting polymer was washed with additional water and then dried under vacuum at 60° C.

### Example 11

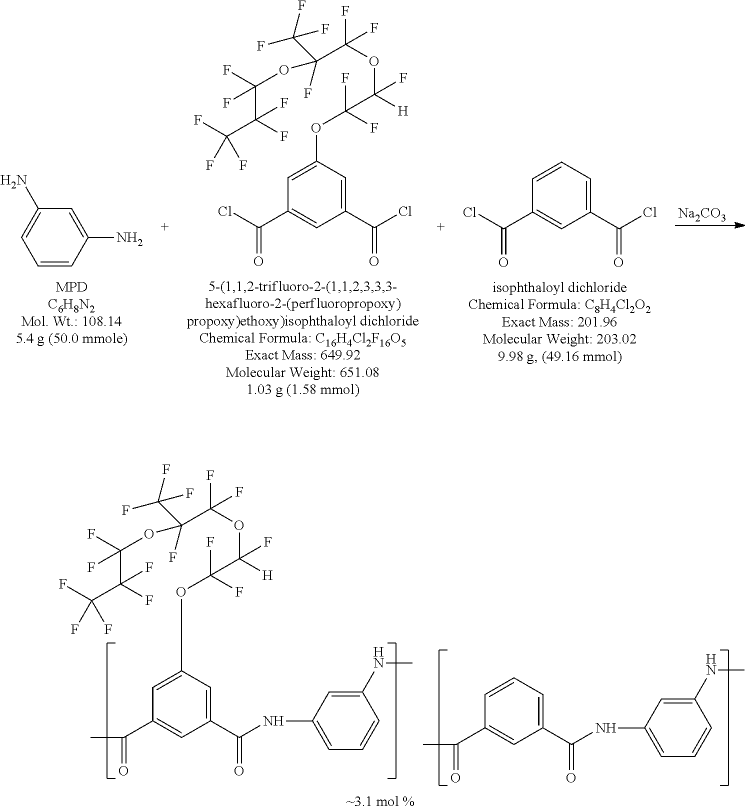

The indicated diacid chlorides were weighed out in a. dry box in a 250 mL flask THF (150 mL) was added and the mixture stirred until a homogeneous solution resulted. The diamine and sodium carbonate (10.6 g) were added to a Waring blender containing water (150 mL). The resulting solution was rapidly stirred and the THF acid chlorides solution added. The resulting mixture was stirred for ˜5 minutes, the polymer was filtered and washed with water (1 liter) and then with acetone (1 liter). The resulting polymer was dried under vacuum at 60° C. for ˜24 hours. The resulting polymer had a IV of 1.177 (H2SO4).

One gram of the resulting polymer was dissolved in NMP (25 mL) and poured into a glass casting plate and placed in an oven at 60° C. under vacuum with a small bleed for ˜72 hours and the resulting film was tested to determine Contact Angles and Surface Energy. Additional specimens were prepared by heating the thus prepared film at 150° C. under vacuum for five hours. Results are shown in Table 1.

TABLE 1

| | | | Contact | Contact | | |
|---|---|---|---|---|---|---|
| | Contact | Contact | Angle | Angle | | |
| | Angle | Angle | Advancing | Receding | Surface | |
| | Ad- | Re- | (Meth- | ((Meth- | tension | |
| | vancing | ceding | ylene | ylene | (Dynes/ | |
| | (water) | (water) | diiodide) | diiodide) | cm) | Polar |
| Air Side | 102 +/− | 50 +/− | 65 +/− | 39.0 +/− | 28.3 | 2.7 |
| | 1.7 | 2.8 | 1.4 | 0.8 | | |
| Glass | 84 +/− | would | 44 +/ | 28 +/− | 39.3 | 8.5 |
| Side | 1.4 | not | 12.0 | 0.4 | | |
| | | recede | | | | |
| Above | | | | | | |
| film dried | | | | | | |
| at 150° C. | | | | | | |
| under | | | | | | |
| vacuum | | | | | | |
| for 5 | | | | | | |
| hours | | | | | | |
| Air Side | 111 +/− | 71 +/− | 76 +/− | 45 +/ | 23.8 | 0.4 |
| | 1.3 | 1.1 | 1.4 | 1.9 | | |
| Glass | 89 +/− | would | 56 +/− | 32 +/− | 33.4 | 7.4 |
| Side | 1.5 | not | 2.9 | 1.6 | | |
| | | recede | | | | |
| Teflon* | 117 +/− | 97 +/− | 88 +/− | 55 +/− | 18.6 | 0 |
| | 1.3 | 2.3 | 1.4 | 4.6 | | |

What is claimed is:

1. A film comprising a polymer comprising a fluorovinyl ether functionalized aromatic repeat unit represented by the structure (I) 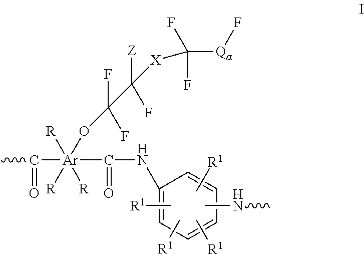
wherein,
Ar represents a benzene or naphthalene radical;
each R is independently H, C₁-C₁₀ alkyl, C₅-C₁₅ aryl, C₆-C₂₀ arylalkyl; OH, or a radical represented by the structure (II) 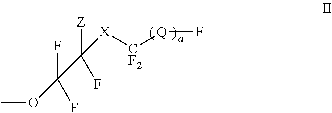
with the proviso that only one R can be OH or the radical represented by the structure (II);
each R1 is independently H, C1-C10 alkyl, C5-C15 aryl, C6-C20 arylalkyl;
X is O or CF₂;
Z is H, Cl, or Br;
a=0 or 1;
and,
Q is represented by the structure (Ia) 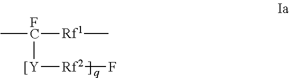
wherein q=0-10;
Y is O or CF₂;
Rf¹ is (CF₂)ₙ, wherein n is 0-10;
and,
Rf² is (CF₂)ₚ, wherein p is 0-10, with the proviso that when p is 0, Y is CF₂.

2. The film of claim 1 wherein in the polymer Ar is a benzene radical.

3. The film of claim 1 wherein in the polymer each R is H.

4. The film of claim 1 wherein in the polymer one R is represented by the structure (II) and the remaining two R⁵ are each H.

5. The film of claim 1 wherein in the polymer each R¹ is H.

6. The film of claim 1 wherein in the polymer X is O.

7. The film of claim 1 wherein in the polymer X is CF₂.

8. The film of claim 1 wherein in the polymer Y is O.

9. The film of claim 1 wherein in the polymer Y is CF₂.

10. The film of claim 1 wherein in the polymer Z is Cl.

11. The film of claim 1 wherein in the polymer one R is represented by the structure (II), one Z is H, and one Z is Cl.

12. The film of claim 1 wherein in the polymer Rf¹ is CF₂.

13. The film of claim 1 wherein in the polymer Rf² is CF₂.

14. The film of claim 1 wherein in the polymer p=0 and Y is CF₂.

15. The film of claim 1 wherein in the polymer Ar is a benzene radical, each R is H, Z is Cl, each R¹ is H, X is O, Y is O, Rf¹ is CF₂, and Rf² is perfluoropropenyl, and q=1.

16. The film of claim 1 wherein in the polymer further comprises aramid repeat units represented by the structure (V), 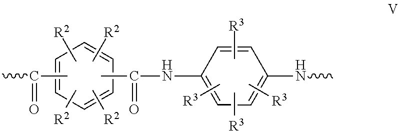
wherein each R² is independently H or alkyl, and each R³ is independently H or alkyl.

17. The film of claim 16 wherein in the polymer all the R²s are H, and all the R³s are H.
